(19) United States
(12) Patent Application Publication
(10) Pub. No.: US 2011/0216647 A1
(43) Pub. Date: Sep. 8, 2011

(54) TELEPHONE SYSTEM, GATEWAY FOR TELEPHONE SYSTEM, AND REDUNDANCY SWITCHING METHOD

(75) Inventor: Satoshi Nishiyama, Hino-shi (JP)

(73) Assignee: KABUSHIKI KAISHA TOSHIBA, TOKYO (JP)

(21) Appl. No.: 13/108,941

(22) Filed: May 16, 2011

Related U.S. Application Data
(63) Continuation of application No. 12/604,166, filed on Oct. 22, 2009.

(30) Foreign Application Priority Data
Nov. 21, 2008 (JP) 2008-298544

(51) Int. Cl. G06F 11/00

(52) U.S. Cl. 370/225

(57) ABSTRACT

According to one embodiment of the invention, there is provided a telephone system comprises gateways used to convert each other's protocols of IP network and PSTN. One of the gateways selectively serves as a main gateway, and the other gateways serve as slave gateways controlled by main gateway. Each of gateways includes a control channel manager, an operation controller and a determination module. Control channel manager of the main gateway controls speech data individually sent and received by gateways, based on a control signal of a control channel of PSTN. Operation controller controls redundancy switching between the plurality of gateways upon occurrence of a fault. Determination module determines whether the fault is associated with control channel. When the fault is associated with control channel, determination module notifies a slave gateway of message used to activate control channel manager of the slave gateway via IP network.

### CROSS-REFERENCE TO RELATED APPLICATIONS

This application is a continuation of U.S. patent application Ser. No. 12/604,166 filed on Oct. 22, 2009 and is incorporated herein by reference. This application is based upon and claims the benefit of priority from Japanese Patent Application No. 2008-298544, filed Nov. 21, 2008, the entire contents of which are incorporated herein by reference.

### BACKGROUND

1. Field

One embodiment of the invention relates to a telephone system which implements speech communications via, for example, an Internet Protocol (IP) network and, more particularly, to a telephone system of this type and a gateway which converts protocols between different networks including an IP network.

2. Description of the Related Art

Systems which realize speech communication via a packet-switched network are known. Of these systems, Voice over IP (VoIP), which uses an Internet Protocol (IP) network, has been put into practical use. In spite of this, a public switched telephone network (PSTN) including the public network, private networks, and the like is still mainstream, and both systems currently coexist.

Hence, a gateway is arranged in an interface between the IP network and PSTN to mask their protocol differences. A system in which a plurality of gateways are parallelly operated to increase the accommodation channel capacity and to improve fault tolerance by means of redundancy is also known (for example, see Jpn. Pat. Appln. KOKAI Publication No. 2007-181079).

In a system of such mode, each of the plurality of gateways has a protocol conversion function between the IP network and PSTN, but an arbitrary one gateway normally relays control signals (signaling information) between the IP network and PSTN. Speech data associated with the plurality of gateways are controlled by exchanging signaling information via this one gateway.

A system of this type includes a host apparatus (to be referred to as a communication server hereinafter) having a higher rank than the gateway, and it is a common practice to execute redundancy switching processing at the initiative of the communication server upon occurrence of faults. In Jpn. Pat. Appln. KOKAI Publication No. 2007-181079, a communication route control apparatus has that function. That is, when a gateway which has caused any fault notifies the communication server of that fault, the communication server mainly executes recovery processing including switching of gateways.

In the existing technique, the communication server mainly executes redundancy switching between gateways. For this reason, an unexpected processing load is imposed on the communication server upon occurrence of faults of the gateway, and may disturb processing of other tasks. Hence, some measures are demanded.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a system block diagram showing an embodiment of a telephone system according to the invention;

FIG. 2 is a functional block diagram showing an example of gateways G1 to G3 in FIG. 1;

FIG. 3 shows an example of a management table T stored in gateways G1 to G3 in FIG. 1;

FIG. 4 is a flowchart showing the recovery processing sequence in a main gateway in a case in which a fault has occurred in the main gateway; and

FIG. 5 is a flowchart showing the recovery processing sequence in a slave gateway in a case in which a fault has occurred in the main gateway.

### DETAILED DESCRIPTION

Various embodiments according to the invention will be described hereinafter with reference to the accompanying drawings. In general, according to one embodiment of the invention, there is provided a telephone system includes a plurality of gateways used to convert each other's protocols of a first network of a packet-switched type and a second network of a circuit-switched type. One of the gateways selectively serves as a main gateway, and the other gateways serve as slave gateways which are controlled by the main gateway. Each of the plurality of gateways including a control channel management module, an operation controller and a determination module. The control channel management module controls, when the gateway is the main gateway, speech data individually sent and received by the plurality of gateways, based on a control signal of a control channel of the second network. The operation controller controls redundancy switching between the gateways upon occurrence of a fault. The determination module determines whether or not the fault is a fault associated with the control channel. When the fault is a fault associated with the control channel, the determination module notifies the slave gateway of an invocation instruction message used to activate the control channel management module of any of the slave gateways via the first network.

By taking such means, at the time of occurrence of a fault associated with a control channel, a main gateway which detected this fault outputs an invocation instruction message, used to activate a control channel management module, to (all or a selected one of) other slave gateways. Upon reception of this instruction, each slave gateway immediately activates the control channel management module to execute redundancy switching between gateways in cooperation with an operation controller. Such operations can be attained since the respective gateways are connected not only to a circuit-switched network (second network) but also to a packet-switched network (first network). The invention focuses attention on this point, and implements message exchange between gateways via the first network. Therefore, upon execution of redundancy switching associated with at least a control-channel-related fault, no intervention of a communication server is required, thus reducing the load on the communication server.

According to the invention, a telephone system and a gateway for the telephone system, and a redundancy switching method, which can reduce the load on the communication server upon occurrence of a fault, can be provided.

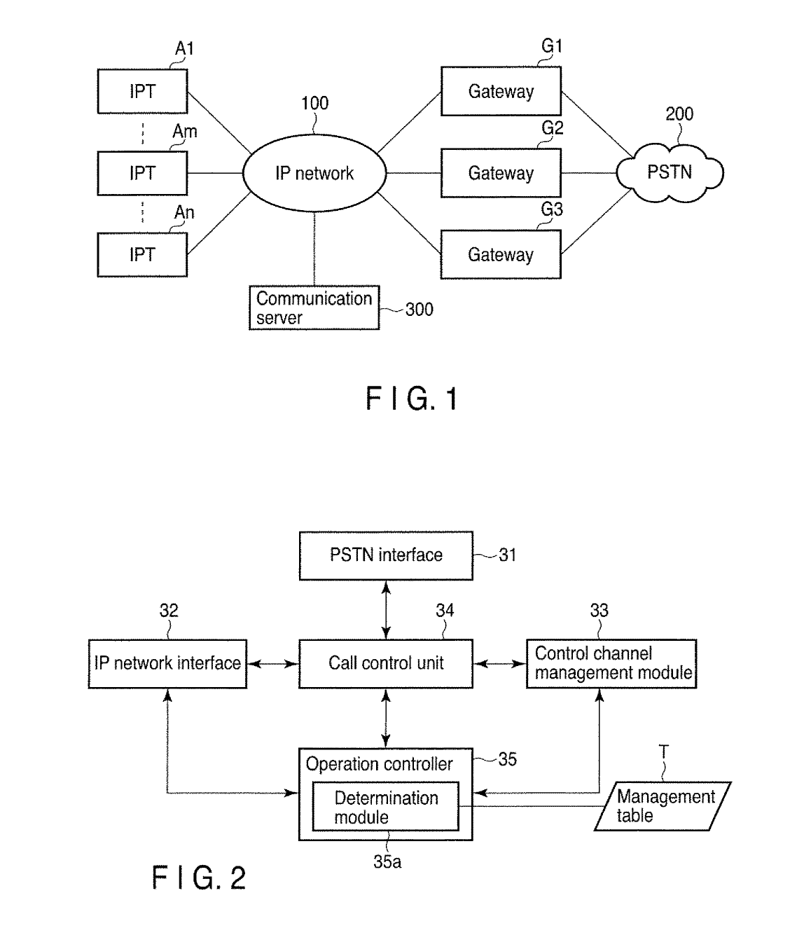

FIG. 1 is a system block diagram showing an embodiment of a telephone system according to the invention. This system is formed by connecting an IP network 100 to which a plurality of IP terminals (IPTs) A1 to An belong, and a PSTN 200 to each other via a plurality of gateways G1 to G3. To the IP network 100, a communication server 300 which executes control associated with telephone communications including call control signaling is connected. Note that the IP network 100 is a packet-switched network such as a local area network (LAN), wide area network (WAN), or an internetwork such as the Internet.

In the system of FIG. 1, a gateway which includes an active control channel and exchanges control signals of the communication server 300 and PSTN 200 will be referred to as a main gateway. Also, a gateway which operates in response to a control signal transferred from the main gateway will be referred to as a slave gateway. In this embodiment, gateway G1 serves as a main gateway, and gateways G2 and G3, which operate in response to a control signal transferred from gateway G1, serve as slave gateways.

FIG. 2 is a functional block diagram showing an example of gateway G1 shown in FIG. 1. Gateways G2 and G3 also have the same arrangement. Gateway G1 includes a PSTN interface 31, IP network interface 32, control channel management module 33, call control unit 34, and operation controller 35.

The PSTN interface 31 takes charge of an interface function with respect to the PSTN 200. That is, the PSTN interface 31 exchanges control signals (signaling information) with the PSTN 200. Also, the PSTN interface 31 is an interface which forms a link with a communication partner in the PSTN 200 by a circuit switching method, and implements speech communications on this link.

The IP network interface 32 takes charge of an interface function with respect to the IP network 100. That is, the IP network interface 32 is an interface which exchanges control signals and speech streams using IP packets with the IP network 100.

The control channel management module 33 controls exchange of control signals between the gateway and the PSTN 200. Especially, in this embodiment, the control channel management module 33 has a function of exchanging an instruction message with another gateway via the IP network 100. This instruction message is used to control processing of signaling information in the other gateway.

Note that in the gateway (slave gateway) which operates in response to processing of control signals by another gateway, the control channel management module 33 is in a standby state, i.e., is inactive. The control channel management module 33 in the standby state is activated upon reception of an instruction message from another gateway, and immediately starts a recovery operation from a fault.

The call control unit 34 executes all processes associated with calls the origination of which it is associated with. That is, the call control unit 34 controls, with respect to a call, to exchange messages with the IP network 100, to decide messages to be exchanged with the PSTN 200, to manage a call state, to output a tone, and to decide a speech connection timing.

The operation controller 35 executes all processes associated with fault detection processing and recovery processing from a fault. Especially, in this embodiment, the operation controller 35 includes a determination module 35a as its processing function block. The determination module 35a has a function of determining a recovery method from a fault, and automatically selects and executes one of a plurality of recovery methods upon occurrence of a fault. In this embodiment, the determination module 35a has a function of notifying the control channel management module 33 of another gateway in the standby state of an invocation instruction message.

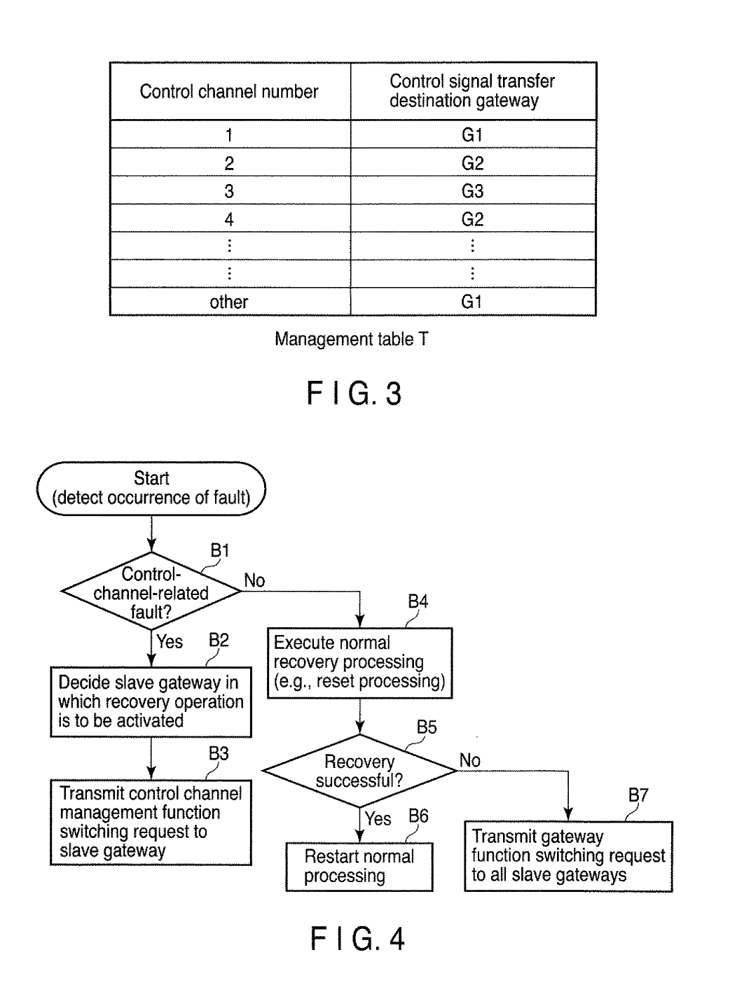

Furthermore, gateway G1 includes a management table T as a database, which is stored in a storage device such as a hard disk drive. FIG. 3 shows an example of the management table T. The management table T is used to decide a transfer destination of a control signal received from the PSTN 200 in a state in which the gateway serves as the main gateway. Upon reception of a control signal from the PSTN 200, the main gateway decides a transfer destination of that control signal with reference to the management table T.

That is, there are a plurality of transmission channels of control signals, and a gateway to which that control signal is to be transferred is different for each transmission channel. Hence, by storing the management table T which associates the control channel numbers and transfer destinations with each other in the main gateway in advance, the main gateway can decide the transfer destination of the control signal. In FIG. 3, the transfer destination of a control signal of a channel with a control channel number “1” (control channel 1) is gateway G1. When gateway G1 is the main gateway, the control signal of control channel 1 is processed by gateway G1 itself. Control signals of control channels 2 and 4 are transferred to gateway G2. A control signal of control channel 3 is transferred to gateway G3. Note that since any of gateways G1 to G3 can serve as a main gateway depending on fault occurrence modes, the management table T is stored in all gateways G1 to G3 to have the same contents. The operation in the above arrangement will be described below.

FIG. 4 is a flowchart showing the recovery processing sequence in the main gateway in a case in which a fault has occurred in the main gateway. That is, the sequence shown in FIG. 4 is executed by the gateway in which the control channel management module 33 is active at the time of occurrence of a fault. In FIG. 4, when the operation controller 35 of the main gateway detects occurrence of a fault, the determination module 35a checks if this fault is a control-channel-related fault (block B1). If this fault is a control-channel-related fault (Yes in block B1), the determination module 35a specifies another gateway to serve as a new main gateway (block B2), and transmits a control channel management function switching request message to the gateway which serves as a slave gateway at that time (block B3). This message is an instruction message which instructs the slave gateway to inherit control associated with exchange of control signals on control channels, and is output from the IP network interface 32 onto the IP network 100.

If the fault is not a control-channel-related fault (No in block B1), the determination module 35a executes normal recovery processing (e.g., reset processing) (block B4), and checks if the recovery processing has succeeded (block B5). If the recovery processing has succeeded, normal processing is restarted (block B6). However, if the recovery processing has failed, the IP network interface 32 broadcasts a gateway function switching request message to all the slave gateways (block B7). The recovery processing sequence on the slave gateway side in the same situation will be described below.

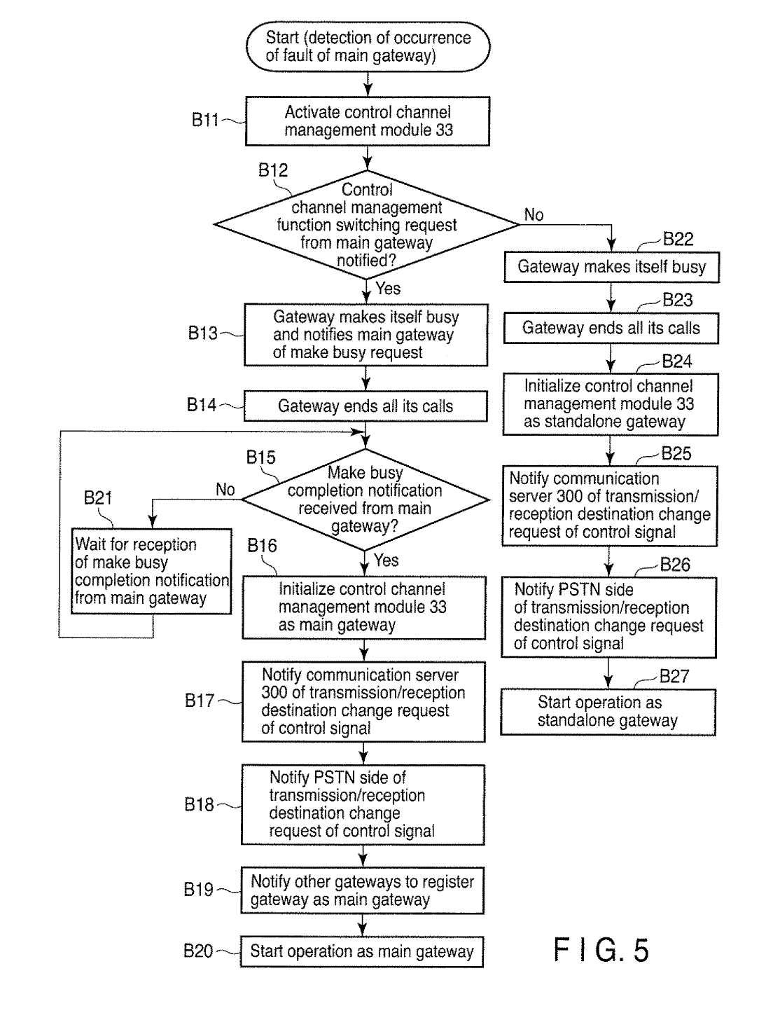

FIG. 5 is a flowchart showing the recovery processing sequence in the slave gateway in a case in which a fault has occurred in the main gateway. That is, the sequence in FIG. 5 is executed in a gateway in which the control channel management module 33 is in the standby state at the time of occurrence of a fault. Referring to FIG. 5, the operation controller 35 of the slave gateway, which detects occurrence of a fault in the main gateway, immediately activates the control channel management module 33 which is in the standby state at that time (block B11). A fault is detected by the operation controller 35, for example, when the IP network interface 32 (FIG. 2) receives a fault-related control packet transferred from the main gateway via the IP network 100 or when a keep alive signal periodically transmitted from the main gateway is not reached.

Then, this slave gateway checks whether or not a control channel management switching request message from the main gateway is received via the IP network 100 (block B12). If the message is not received (No in block B12), the slave gateway sets itself to the busy state so as not to accept any newly originated call (block B21). Furthermore, the call control unit 34 ends all calls in itself, and if all calls are ended (block B23), the slave gateway initializes the control channel management module 33 (FIG. 2) to make itself operate as a standalone gateway (block B24).

Then, this slave gateway notifies the communication server 300 of a transmission/reception destination change request message of control signals via the IP network 100 (block B25), and notifies the PSTN 200 of a transmission/reception destination change request message of control signals (block B26). After the sequence described so far, the gateway which was the slave gateway before occurrence of a fault begins to operate as a standalone gateway (block B27).

On the other hand, if the control channel management function switching request message is received from the main gateway via the IP network 100 in block B12 (Yes), this slave gateway sets itself in the busy state, and notifies the main gateway of a make busy request message via the IP network 100 (block B13). After that, the call control unit 34 ends all calls in itself (block B14), and if all calls are ended, the slave gateway checks whether a make busy completion notification message is received from the main gateway (block B15). If the message is not received, the slave gateway waits until the make busy completion notification message is reached from the main gateway (block B21).

If that message is received in block B15 (Yes), the slave gateway initializes the control channel management module 33 to make itself operate as a main gateway after switching (block B16). Upon completion of initialization, the slave gateway notifies the communication server 300 of a transmission/reception destination change request message of control signals via the IP network 100 (block B17), and notifies the PSTN 200 of a transmission/reception destination change request message of control signals (block B18). Furthermore, the slave gateway notifies other gateways to register itself as a main gateway via the IP network 100 (block B19). Upon completion of the aforementioned sequence, this slave gateway begins to operate as a main gateway (block B19).

As described above, according to this embodiment, when a fault has occurred in the main gateway which exchanges control signals with the PSTN 200, the main gateway which detected this fault determines a cause of the fault. If the cause arises from a control channel, messages are exchanged between the main gateway and slave gateway via the IP network 100, thus attaining redundancy switching for switching the slave gateway to the main gateway.

In this way, in case of a fault which arises from a control channel, the gateways communicate by themselves with each other to switch a gateway which exchanges control signals with the PSTN 200 side. In this way, the recovery processing can be executed without imposing any load on the communication server 300. Therefore, the load on the communication server 300 upon occurrence of a fault can be reduced, thus preventing a performance drop of the communication server 300.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system, which comprises a plurality of gateways used to convert each other's protocols of a first network of a packet-switched type and a second network of a circuit-switched type, and in which one of the plurality of the gateways selectively serves as a main gateway, and the other gateways serve as slave gateways which are controlled by the main gateway, each of the plurality of gateways comprising:
a control channel management module configured to control, when the control channel management module included in the one of the plurality of gateways that is the main gateway, speech data individually sent and received by the plurality of gateways, based on a control signal of a control channel of the second network;
an operation controller configured to control redundancy switching between the plurality of gateways upon occurrence of a fault; and
a determination module configured to determine whether the fault is associated with the control channel,
wherein when the fault is associated with the control channel, the determination module notifies one of the slave gateways of an invocation instruction message used to activate the control channel management module of the one of the slave gateways via the first network.

2. The system of claim 1, wherein
the first network is an Internet Protocol (IP) network, and
the second network is a Public Switched Telephone Network (PSTN).

3. The system of claim 1, wherein
the operation controller executes the redundancy switching after all calls in the one of the slave gateways are ended.

4. A gateway applied to a telephone system which comprises a plurality of gateways used to convert each other's protocols of a first network of a packet-switched type and a second network of a circuit-switched type, the gateway is one of the plurality of gateways, the gateway comprising:
a control channel management module configured to control speech data individually sent and received by the plurality of gateways based on a control signal of a control channel of the second network;
an operation controller configured to control redundancy switching between the plurality of the gateways upon occurrence of a fault; and
a determination module configured to determine whether the fault is associated with the control channel,
wherein when the fault is associated with the control channel, the determination module notifies another gateway of the plurality of gateways of an invocation instruction message used to activate the control channel management module that is in a standby state in the another gateway of the plurality of gateways via the first network.

5. The gateway of claim 4, wherein
the first network is an Internet Protocol (IP) network, and
the second network is a Public Switched Telephone Network (PSTN).

6. The gateway of claim 4, wherein
the another gateway of the plurality of gateways is a slave gateway, and
the operation controller executes the redundancy switching after all calls in the slave gateway are ended.

7. A redundancy switching method between a plurality of gateways applied to a telephone system, which comprises the plurality of gateways used to convert each other's protocols of a first network of a packet-switched type and a second network of a circuit-switched type, the method comprising:
determining, by a main gateway which controls speech data individually sent and received by the plurality of gateways based on a control signal of a control channel of the second network, whether a fault that has occurred is associated with the control channel; and
notifying, by the main gateway, at least one another gateway of an invocation instruction message that instructs the at least one another gateway to inherit control associated with exchange of the control signal via the first network, when the fault is associated with the control channel.

8. The method of claim 7, wherein
the first network is an Internet Protocol (IP) network, and
the second network is a Public Switched Telephone Network (PSTN).

9. The method of claim 7, wherein
the at least one another gateway is a slave gateway, and
the operation controller executes the redundancy switching after all calls in the slave gateway are ended.
